(19) United States
(12) Patent Application Publication
(10) Pub. No.: US 2026/0180451 A1
(43) Pub. Date: Jun. 25, 2026

(54) UVC LIGHT DISINFECTION MAKEUP BOX, CONTROL CIRCUIT, AND CONTROL METHOD THEREOF

(71) Applicant: Shenzhen Juduo Technology Co., Ltd., Shenzhen (CN)

(72) Inventor: HU LIN, Shenzhen (CN)

(21) Appl. No.: 19/539,173

(22) Filed: Feb. 13, 2026

(30) Foreign Application Priority Data
Nov. 7, 2025 (CN) 202511628885.4

(51) Int. Cl. H02M 3/158; H02J 7/00

(52) U.S. Cl. CPC H02M 3/1584; H02J 7/00

(57) ABSTRACT

Provided are a UVC light disinfection makeup box, a control circuit, and a control method thereof, the UVC light disinfection makeup box includes a housing component, a control component, and a lens component. The housing component includes a bottom shell and a flip cover, the flip cover is rotatably connected to the bottom shell. The control component is integrated into the bottom shell, the lens component is provided inside the flip cover. The control component is linked with the housing component and the lens component. After collecting a state sensing signal of the housing component and processing it, a control signal is output to the lens component and its own execution component to achieve automatic control of disinfection, supplementary lighting, and state display functions. The lens component and the housing component are adapted accordingly. When the flip cover is closed, the UVC ultraviolet disinfection light will automatically start.

### CROSS-REFERENCE TO RELATED APPLICATIONS

This application claims priority to Chinese Patent Application No. 202511628885.4 filed on November 07, 2025, which is hereby incorporated by reference in its entirety.

### TECHNICAL FIELD

The present disclosure relates to the field of makeup box technologies, and in particular, to a UVC light disinfection makeup box, a control circuit, and a control method thereof.

### BACKGROUND

In the traditional makeup box field, product design often focuses on storage function and appearance aesthetics, and generally lacks disinfection mechanisms for beauty tools and powders. Tools such as powder puffs and makeup brushes are prone to adhere to sebum and dust during long-term use, which can breed bacteria, mites and other microorganisms. Direct contact with the skin may cause skin problems such as acne and allergies. However, existing solutions rely on external disinfection equipment, which not only increases additional costs for users, but also has the disadvantages of cumbersome operation and inability to integrate with makeup boxes, making it difficult to meet users’ demand for instant disinfection of beauty tools.

The traditional makeup box’s supplementary lighting function has obvious limitations: some products completely lack supplementary lighting design, rendering it difficult to ensure makeup accuracy in low light environments. A few products with supplementary lighting functions also require manual opening of the switch, which is inconvenient to operate. At the same time, the existing makeup box cannot provide intuitive feedback on the working state, and users cannot quickly judge whether disinfection is in progress, whether the battery is fully charged, and whether the charging is completed, resulting in problems such as “unclear disinfection” and “battery anxiety” during use, and the overall user experience is poor.

### SUMMARY

In response to the shortcomings of existing technology, the present disclosure provides a UVC light disinfection makeup box, a control circuit, and a control method thereof, which solves the problem of “traditional makeup boxes lacking disinfection mechanisms for beauty tools and powders, relying on external disinfection equipment”.

To achieve the above objectives, the present disclosure is implemented through the following technical solution: a UVC light disinfection makeup box, including a housing component, a control component, and a lens component; where the housing component includes a bottom shell and a flip cover, the flip cover is rotatably connected to the bottom shell; the control component is integrated into the bottom shell, and the lens component is provided inside the flip cover; the control component is linked with the housing component and the lens component through for electrical signal transmission, after collecting a state sensing signal of the housing component and processing it, a control signal is output to the lens component and an execution component to achieve automatic control of disinfection, supplementary lighting, and state display functions; where the lens component is matched with the housing component.

In some embodiments of the present disclosure, the housing component further includes a powder holder, an aluminum dish for loading powder material, a powder puff, a flip magnet, a hall induction magnet, a transparent light guide plate, a transparent silicone inner cover, a rear button cover, and a shoulder magnet; the powder holder is fixedly provided inside the bottom shell, and the aluminum dish for loading powder material is configured to be detachably connected to the powder holder; the powder puff is provided above the powder holder and corresponding to the aluminum dish for loading powder material; the flip magnet is fixedly provided inside the flip cover, the hall induction magnet is fixedly provided inside the transparent shoulder cover and aligned with the flip magnet, the transparent light guide plate is provided inside the bottom shell and close to the control component, the transparent silicone inner cover covers an outer side of a lens, the rear button cover is fixedly provided to a tail of the bottom shell, and the shoulder magnet is fixedly provided inside the transparent shoulder cover to enhance connection and fixation between the transparent shoulder cover and the bottom shell; the control component includes a PCB control board, a hall sensor, a UVC ultraviolet disinfection light, an LED colorful atmosphere light, and a battery; the PCB control board is fixedly provided inside the bottom shell, and the hall sensor, the UVC ultraviolet disinfection light, and the LED colorful atmosphere light are respectively electrically connected and fixedly provided to the PCB control board through a welding circuit; the battery is electrically connected to the PCB control board through a power supply circuit; the flip magnet and the hall induction magnet output induction electrical signals to the hall sensor through a magneto electric conversion circuit; the hall sensor transmits the electrical signals to the PCB control board, and the PCB control board controls on/off of a circuit of the UVC ultraviolet disinfection light and the LED colorful atmosphere light through a drive circuit.

In some embodiments of the present disclosure, the lens component includes the lens, a lens PCB light board, an LED white light, and a lens PCB light board output port, the lens is fixedly provided at an inner side of the flip cover, the lens PCB light board is fixedly provided inside the flip cover and provided on one side of the lens, the LED white light is fixedly provided to the lens PCB light board through the welding circuit and is aligned with the lens, and the lens PCB light board is provided with a lens PCB light board input port and the lens PCB light board output port; the lens PCB light board output port is electrically connected to the PCB control board through a signal transmission circuit via the lens PCB light board input port, and the lens PCB light board output port cooperates to achieve stable transmission of circuit signals; the PCB control board outputs a supplementary lighting control electrical signal to drive the LED white light circuit to conduct, thereby achieving automatic supplementary lighting when the flip cover is opened.

In some embodiments of the present disclosure, the flip cover is rotatably connected to the bottom shell through a hinge structure, and when the flip cover is closed, the flip magnet and the hall induction magnet are attracted, the hall sensor is triggered to generate an induction electrical signal, and the electrical signal is sent to the PCB control board through the signal transmission circuit; the PCB control board starts the UVC ultraviolet disinfection light to work for a preset time, and controls the LED colorful atmosphere light to output a blue light state signal through an atmosphere light control circuit; when the flip cover is opened, the hall sensor stops outputting the induction electrical signal, and the PCB control board immediately turns off the UVC ultraviolet disinfection light and starts the LED white light to achieve functional linkage control.

A control circuit for a UVC light disinfection makeup box, including a core control unit, an induction unit, an execution unit, and a power supply unit; the induction unit is configured to collect a mechanical state signal of the UVC light disinfection makeup box and convert it into an electrical signal; the core control unit receives the electrical signal from the induction unit, processes it internally, and outputs a control electrical signal to the execution unit; the power supply unit provides stable working power for the core control unit, the induction unit, and the execution unit; through collection, processing, and output the electrical signal, a linkage control of disinfection, supplementary lighting, state display, and charging is achieved.

In some embodiments of the present disclosure, the core control unit is a PCB control board, and the PCB control board integrates a signal processing circuit, a drive control circuit, and a voltage detection circuit, and they are configured to analyze the electrical signal transmitted by the induction unit, output the control electrical signal to the execution unit, and monitor a voltage state of the power supply unit in real time; when the voltage is lower than a preset threshold, a low battery warning signal is output through the execution unit.

In some embodiments of the present disclosure, the induction unit is a hall sensor, and the hall sensor cooperates with the flip magnet and the hall induction magnet of the UVC light disinfection makeup box through a magneto electric conversion circuit to convert opening and closing mechanical state of the flip cover into high and low level electrical signals, and sends them to the core control unit through a signal transmission circuit; the execution unit includes a UVC ultraviolet disinfection light drive circuit, an LED colorful atmosphere light control circuit, and an LED white light fill circuit, which respectively receive the control signal from the core control unit to achieve precise control of start and stop of the UVC ultraviolet disinfection light, mode adjustment of the LED colorful atmosphere light, and a conduction of a circuit of the LED white light.

In some embodiments of the present disclosure, the power supply unit includes a battery and a charging management circuit, the battery is electrically connected to the core control unit, the induction unit, and the execution unit through the power supply circuit, thereby providing working power for each unit; the charging management circuit is electrically connected to a USB interface, and converts an external input power supply into an adapted voltage through a rectification and stabilization circuit to charge the battery; a charging state signal is transmitted to the core control unit through a signal feedback circuit.

### A control method of a UVC light disinfection makeup box, including the following steps:

S1: state induction and signal conversion, a hall sensor cooperates with a flip magnet and a hall induction magnet through a magneto electric conversion circuit to detect opening and closing mechanical state of the flip cover in real time, converting a close state into a low-level electrical signal and an open state into a high-level electrical signal, and sending it to a PCB control board through a signal transmission circuit;

S2: signal analysis and instruction generation, after receiving the electrical signal transmitted by the induction unit, the PCB control board analyzes state information through an integrated signal processing circuit and a voltage detection circuit monitors a voltage state of a power supply unit in real time; when it is a low level, output a control signal to activate a UVC ultraviolet disinfection light and a LED colorful atmosphere light in a blue light mode; when it is a high level, output a control signal to turn off the UVC ultraviolet disinfection light and start the LED white light for supplementary lighting; when a voltage is lower than a preset threshold, output a low battery warning control signal;

S3: instruction execution and function implementation, the execution unit receives an instruction from the PCB control board, a UVC ultraviolet disinfection light drive circuit is turned on, controls the UVC ultraviolet disinfection light to start and work for a preset time, and automatically shuts off after disinfection is completed; the LED atmosphere light control circuit switches modes according to an instruction; the LED white light supplement circuit is turned on, controlling the LED white light to turn on, achieving automatic supplement lighting when the flip cover is opened;

S4: power management and state feedback, the power supply unit provides stable working power to the PCB control board, the hall sensor, and the execution unit through the power supply circuit via the battery.

In some embodiments of the present disclosure, the S4 power management and state feedback further includes the following steps:

S401: charging management: during charging, the charging management circuit receives an external power through a USB interface, rectifies and stabilizes the voltage to charge the battery, and transmits a charging state to the PCB control board through a signal feedback circuit, the LED colorful atmosphere light then feeds back to a user, forming a closed-loop management of power supply, control, and feedback.

The present disclosure provides a UVC light disinfection makeup box, a control circuit, and a control method, which have the following beneficial effects.

1. The present disclosure triggers the hall sensor through the adsorption and separation of the flip magnet and the hall induction magnet, which can automatically recognize the opening and closing state of the flip cover. When the flip cover is closed, it automatically starts the UVC ultraviolet disinfection light and works for a preset time, and automatically closes after disinfection is completed. When the flip cover is opened, the power supply of the UVC light is immediately cut off to avoid UV leakage and damage to the skin. The linkage control of closing disinfection and turning on/off the light can be achieved without manual operation, which not only ensures the disinfection effect but also considers the safety of use, thereby solving the pain point of traditional makeup boxes relying on external disinfection equipment.

2. The present disclosure is linked with the lens component and the control component. When the flip cover is opened, the PCB control board automatically drives the LED white light to conduct, and the light accurately covers a lens area, thereby meeting the needs of makeup supplementary lighting in dim environments without manually turning on the supplementary lighting function. At the same time, the LED colorful atmosphere light can provide feedback on the state through different modes, and a user can intuitively judge the working state of the makeup box through the lighting, thereby solving the problems of inconvenient lighting and lack of state feedback in traditional makeup boxes.

3. The aluminum dish for loading powder material of the present disclosure adopts a detachable design. After the powder is used up, only the aluminum dish needs to be replaced to continue using the makeup box body, without discarding the entire product, reducing the cost of use and being more environmentally friendly. The power supply unit is provided with the charging management circuit and the USB interface. The external power supply can safely charge the battery after rectification and stabilization. At the same time, the charging state is transmitted to the PCB control board through the signal feedback circuit, and then real-time feedback is provided by the atmosphere light, thereby forming a closed-loop management of charging, monitoring, and feedback. The overall structure is compact, balancing functionality and portability, enhancing the long-term user experience.

### BRIEF DESCRIPTION OF DRAWINGS

FIG. 1 is a schematic diagram of a three-dimensional structure of an overall device in the present disclosure.

FIG. 2 is a schematic diagram of a three-dimensional disassemble structure of the overall device in the present disclosure.

FIG. 3 is a schematic top view of a three-dimensional structure of a PCB control board and a bottom shell in the present disclosure.

FIG. 4 is a schematic bottom view of a three-dimensional structure of a lens PCB light board in the present disclosure.

FIG. 5 is a schematic diagram of a three-dimensional structure of the overall device in an open state of the present disclosure.

FIG. 6 is a schematic diagram of the three-dimensional structure of a powder puff extraction state of the overall device in the present disclosure.

FIG. 7 is a schematic sectional view of the three-dimensional structure of the overall device in the present disclosure.

FIG. 8 is a flowchart of state sensing and signal conversion in the present disclosure.

FIG. 9 is a flowchart of signal parsing and instruction generation in the present disclosure.

FIG. 10 is a flowchart of instruction execution and function implementation in the present disclosure.

FIG. 11 is a flowchart of power supply management and state feedback in the present disclosure.

FIG. 12 is a schematic diagram of a UVC ultraviolet disinfection light and a connecting circuit in the present disclosure.

FIG. 13 is a schematic diagram of a power circuit of the UVC ultraviolet disinfection light in the present disclosure.

FIG. 14 is a schematic diagram of a control circuit of the UVC ultraviolet disinfection light in the present disclosure.

FIG. 15 is a schematic circuit diagram of a USB interface in the present disclosure.

FIG. 16 is a schematic diagram of a USB interface charging circuit in the present disclosure.

FIG. 17 is a schematic diagram of a power control circuit for a LED colorful atmosphere light in the present disclosure.

FIG. 18 is a schematic diagram of a circuit of the LED colorful atmosphere light in the present disclosure.

FIG. 19 is a schematic diagram of a voltage detection circuit in the present disclosure.

FIG. 20 is a schematic circuit diagram of a hall sensor in the present disclosure.

FIG. 21 is a schematic circuit diagram of a LED white light in the present disclosure.

FIG. 22 is a schematic disassemble diagram of a second embodiment of the present disclosure.

Numeral reference: 11- flip cover; 12- lens PCB light board; 13- flip magnet; 14- transparent silicone inner cover; 15- lens; 16- aluminum dish for loading powder material; 17- hall induction magnet; 18- rear button cover; 19- powder holder; 21- hall sensor; 22- UVC ultraviolet disinfection light; 23- LED colorful atmosphere light; 24- USB interface; 25- Lens PCB light board input port; 31- LED white light; 32- lens PCB light board output port; 110- powder puff; 111- shoulder magnet; 112- transparent shoulder cover; 113- transparent light guide plate; 114- PCB control board; 115- battery; 116- bottom shell; 117- transparent piece; 118- linetightening sheet; 119- convex platform.

### DESCRIPTION OF EMBODIMENTS

Below, the technical solutions in the embodiments of the present disclosure will be clearly and completely described in combination with the accompanying drawings of the present disclosure. Obviously, the described embodiments are only a part of the embodiments of the present disclosure, and not all of them. Based on the embodiments of the present disclosure, all other embodiments obtained by those skilled in the art without creative work are within the protection scope of the present disclosure.

### Embodiments

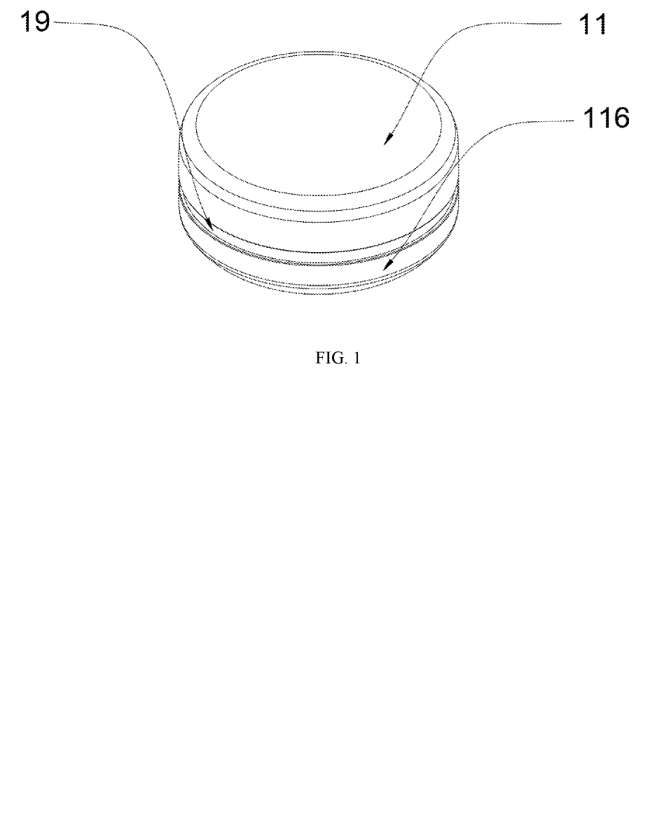

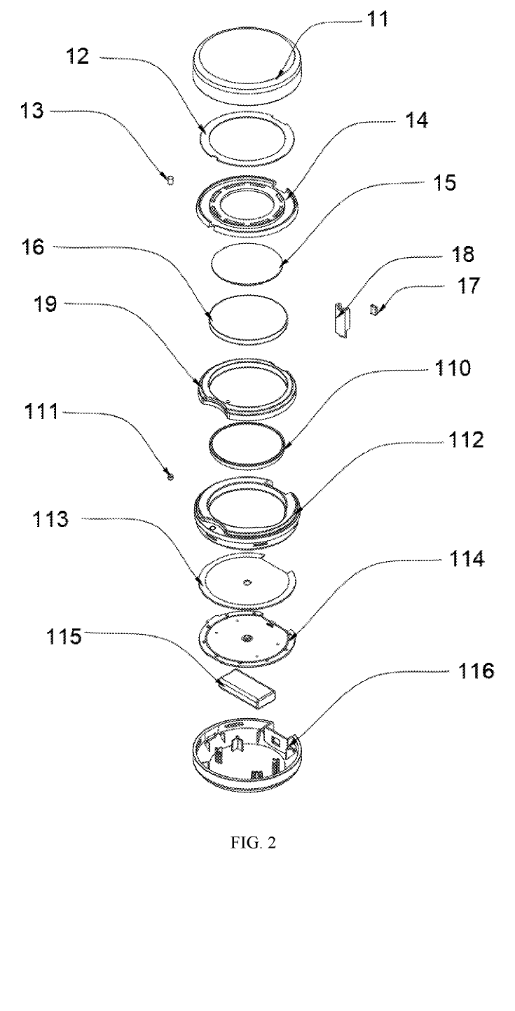

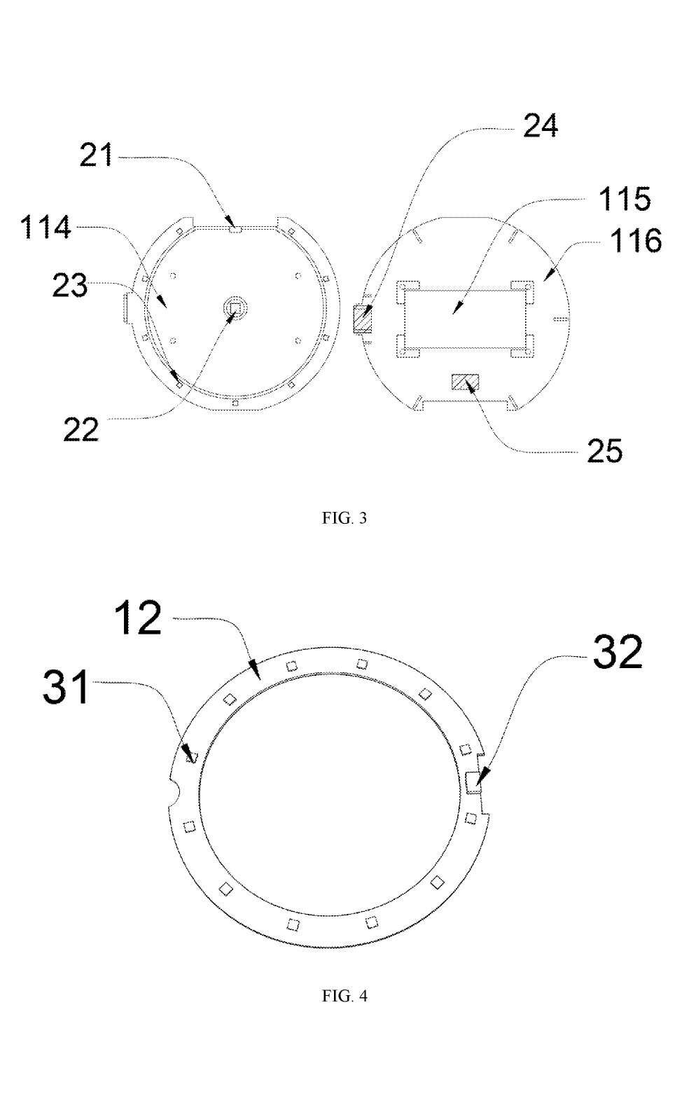

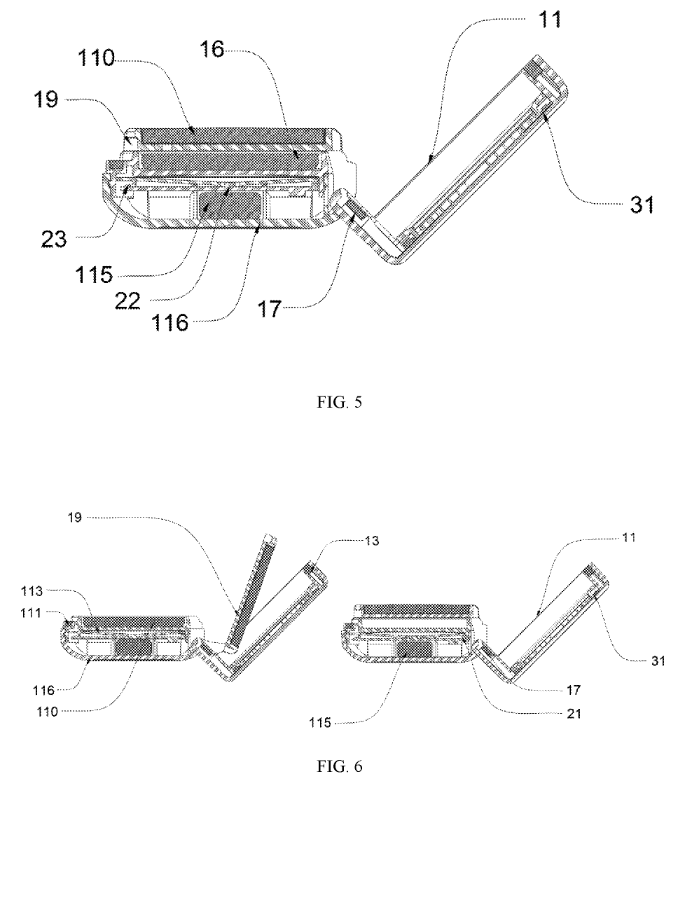

Please refer to FIGS. 1-7. An embodiment of the present disclosure provides a UVC light disinfection makeup box, including a housing component, a control component, and a lens component. The housing component is responsible for carrying protection, the control component serves as a core center to process signals and issue instructions, and the lens component focuses on supplementary lighting and observation, jointly realizing the comprehensive function of the makeup box. The housing component includes a bottom shell 116 and a flip cover 11, the flip cover 11 is rotatably connected to the bottom shell 116. The bottom shell 116 provides stable installation space and protective barriers for all internal components. The flip cover 11 opens and closes the makeup box by rotating, meeting the needs of use and storage. A hinge structure ensures smooth opening and closing and tight closure. The control component is integrated into the bottom shell 116, and the lens component is provided inside the flip cover 11. The control component is provided in the bottom shell to avoid external damage, and the lens component is arranged with the flip cover 11, which can synchronously link the opening and closing states to achieve functional switching, improving the convenience of use. The control component is linked with the housing component and the lens component through electrical signal transmission. After collecting a state sensing signal of the housing component and processing it, a control signal is output to the lens component and its own execution components to achieve automatic control of disinfection, supplementary lighting, and state display functions. The lens component and the housing component are adapted accordingly. The transmission of electrical signals ensures precise and timely instructions, with automatic control that does not require manual operation. The adaptive design ensures accurate alignment between the lens component and the housing when closed, thereby providing both protection and functional effects.

The housing component further includes a powder holder 19, an aluminum dish for loading powder material 16, a powder puff 110, a flip magnet 13, a hall induction magnet 17, a transparent light guide plate 113, a transparent silicone inner cover 14, a rear button cover 18, and a shoulder magnet 111. These components respectively undertake functions such as load bearing, sensing, light transmission, and protection, ensuring the practicality and durability of the makeup box in all aspects. The powder holder 19 is fixedly provided inside the bottom shell 116, thereby providing stable support for the aluminum dish for loading powder material 16 and powder puff 110 to prevent displacement during use. Its fixing structure ensures a firm assembly. The aluminum dish for loading powder material 16 can be detachably connected to the powder holder 19, rendering it convenient to replace the powder separately after it is used up, without the need to discard the entire makeup box, reducing costs and being environmentally friendly. The powder puff 110 is placed above the powder holder 19 and corresponds to the aluminum dish for loading powder material 16, ensuring that the powder puff 110 can accurately dip the powder in the aluminum container and improve the convenience of makeup application. The flip magnet 13 is fixedly provided on an inner side of the flip cover 11, and the hall induction magnet 17 is fixedly provided inside the transparent shoulder cover 112 and aligned with the flip magnet 13. When the two are adsorbed, a magnetic field change is generated, providing triggering conditions for state induction. The transparent light guide plate 113 is provided inside the bottom shell 116 and close to the control component, which can evenly diffuse the ambience light and make the state display more intuitive. The transparent silicone inner cover 14 covers an outer side of the lens 15, providing dust-proof and scratch resistant protection for the lens 15 without affecting the viewing field. The rear button cover 18 is fixed to a tail of the bottom shell 116, thereby covering the internal circuit and beautifying the appearance, and enhancing the sealing performance. The shoulder magnet 111 is fixedly provided inside the transparent shoulder sleeve 112, enhancing the connection and fixation between the transparent shoulder cover 112 and the bottom shell 116, and avoiding loosening during use. The control component includes a PCB control board 114, a Hall sensor 21, a UVC ultraviolet disinfection light 22, an LED colorful atmosphere light 23, and a battery 115. The PCB control board 114 is fixedly provided inside the bottom shell 116 and serves as the control core to coordinate the operation of various components. The Hall sensor 21, the UVC ultraviolet disinfection light 22, and the LED colorful atmosphere light 23 are respectively electrically connected and fixed to the PCB control board 114 through a welding circuit. Welding ensures stable signal and power transmission, and the layout is compact and space saving. The battery 115 is electrically connected to the PCB control board 114 through a power supply circuit, thereby providing independent and stable power for the entire control component to ensure offline use. The flip magnet 13 and the hall induction magnet 17 output induction electrical signals to the hall sensor 21 through a magneto electric conversion circuit, thereby converting magnetic field changes into electrical signals to provide input for control instructions. The hall sensor 21 transmits electrical signals to the PCB control board 114, and the PCB control board 114 controls on/off of a circuit of the UVC ultraviolet disinfection light 22 and the LED colorful atmosphere light 23 through a drive circuit, thereby achieving precise control of disinfection and state display.

The lens component includes a lens 15, a lens PCB light board 12, a LED white light 31, and a lens PCB light board output port 32. The lens is used for observation during makeup, and the light board provides installation and circuit support for the LED white light. The ports ensure signal transmission and jointly achieve the function of supplementary lighting. The lens 15 is fixedly provided on an inner side of the flip cover 11 and made of high transparency material to ensure clear and realistic observation, meeting the precision requirements of makeup. The lens PCB light board 12 is fixedly provided inside the flip cover 11 and provided on one side of the lens 15. Its size is adapted to an internal space of the flip cover, and the installation position is optimized to ensure uniform supplementary lighting. The LED white light 31 is fixed to the lens PCB light board 12 through a welding circuit and aligned with the lens 15. The welding ensures reliable connection, and the alignment setting allows the light to accurately cover the lens, thereby improving the supplementary lighting effect. The lens PCB light board 12 is provided with the lens PCB light board input port 25 and a lens PCB light board output port 32. The Lens PCB light board input port 25 is electrically connected to the PCB control board 114 through a signal transmission circuit to receive the control signal. The lens PCB light board output port 32 cooperates to achieve stable transmission of circuit signals, thus ensuring timely response of the supplementary lighting function. The PCB control board 114 outputs a supplementary lighting control electrical signal to drive a circuit of the LED white light 31 to conduct, thereby achieving automatic supplementary lighting when the flip cover 11 is opened. No manual operation is required, the flip cover will trigger the supplementary lighting immediately, therefore meeting the makeup needs in low light environments and improving the user experience.

The flip cover 11 and the bottom shell 116 are rotatably connected through a hinge structure, the hinge structure has good flexibility and durability, can withstand multiple opening and closing operations, and ensure precise fit with the bottom shell when closed, enhancing sealing performance. When the flip cover 11 is closed, the flip magnet 13 attracts the hall induction magnet 17, triggering the Hall sensor 21 to generate an induction electrical signal. Magnetic adsorption not only fixes the flip cover, but also triggers induction through magnetic field changes to ensure timely and accurate signal generation, laying the foundation for the start of disinfection function. The electrical signal is sent to the PCB control board 114 through the signal transmission circuit, and the PCB control board 114 starts the UVC ultraviolet disinfection light 22 to work for a preset duration. At the same time, the atmosphere light control circuit controls the LED colorful atmosphere light 23 to output a blue light state signal. The preset duration balances sterilization effect and energy saving, and the blue light intuitively indicates that the user is in a disinfection state, rendering it easy to grasp the work progress. When the flip cover 11 is opened, the hall sensor 21 stops outputting induction electrical signals, and the PCB control board 114 immediately turns off the UVC ultraviolet disinfection light 22 and starts the LED white light 31, thereby achieving functional linkage control. Turn off the UVC light to prevent UV rays from leaking and damaging the skin, and activate the supplementary lighting to meet immediate makeup needs, balancing safety and practicality.

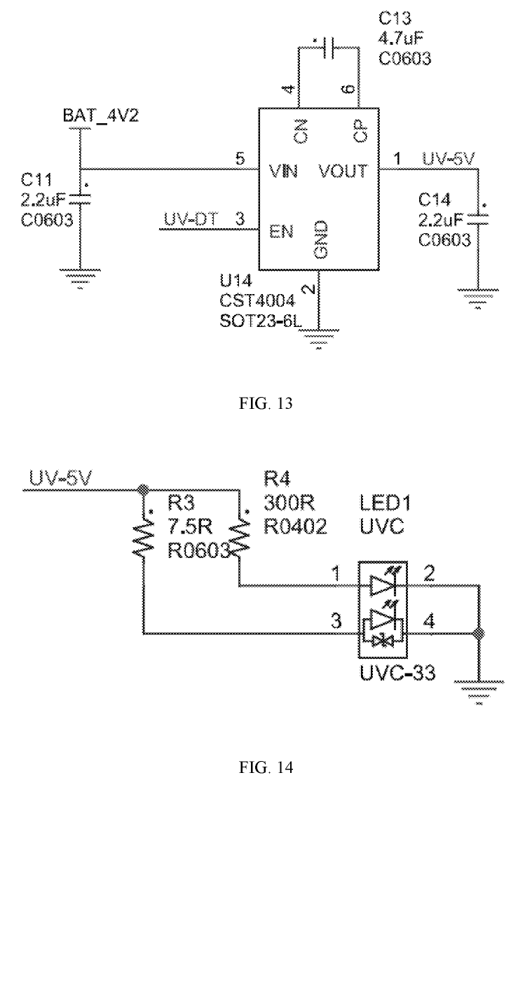

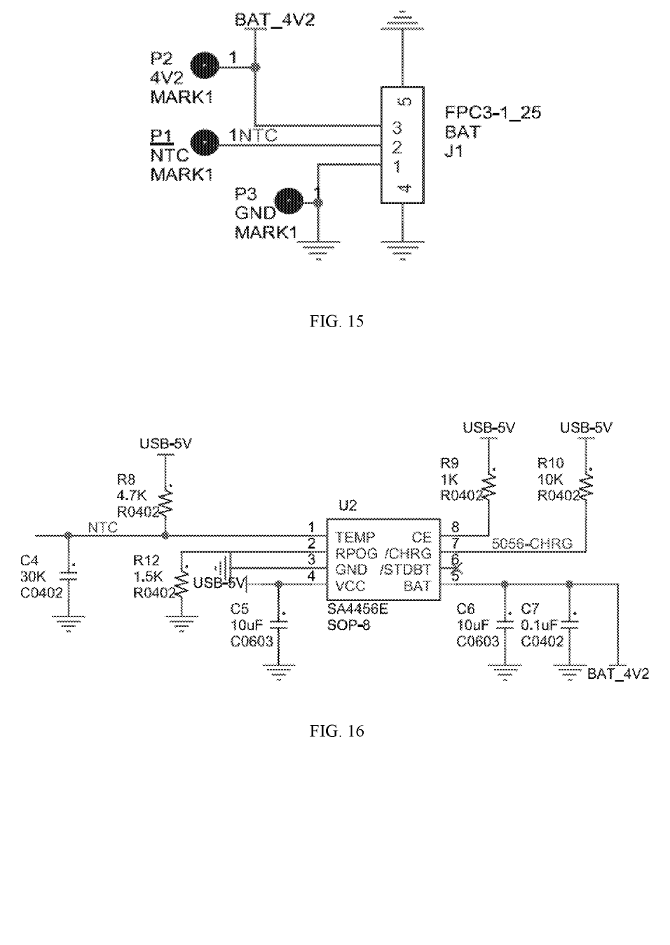

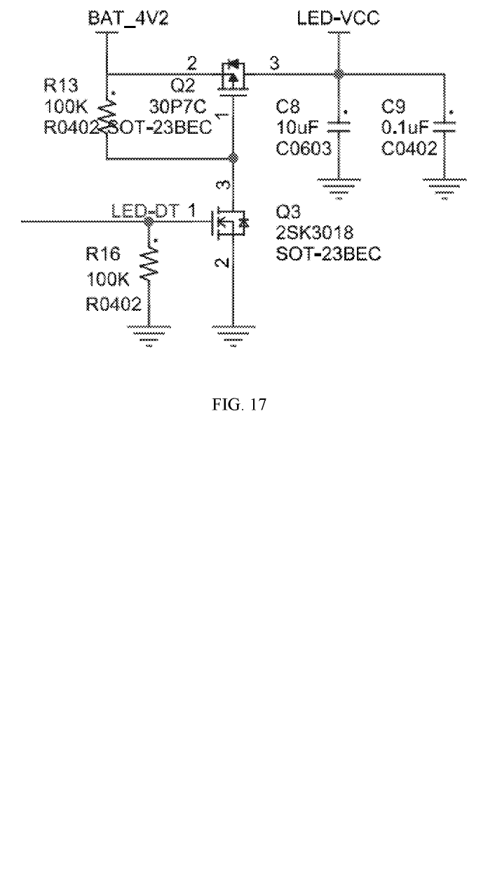

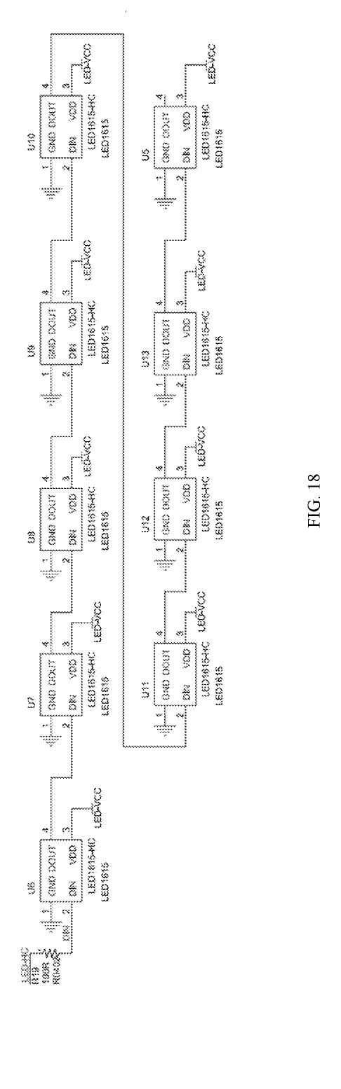

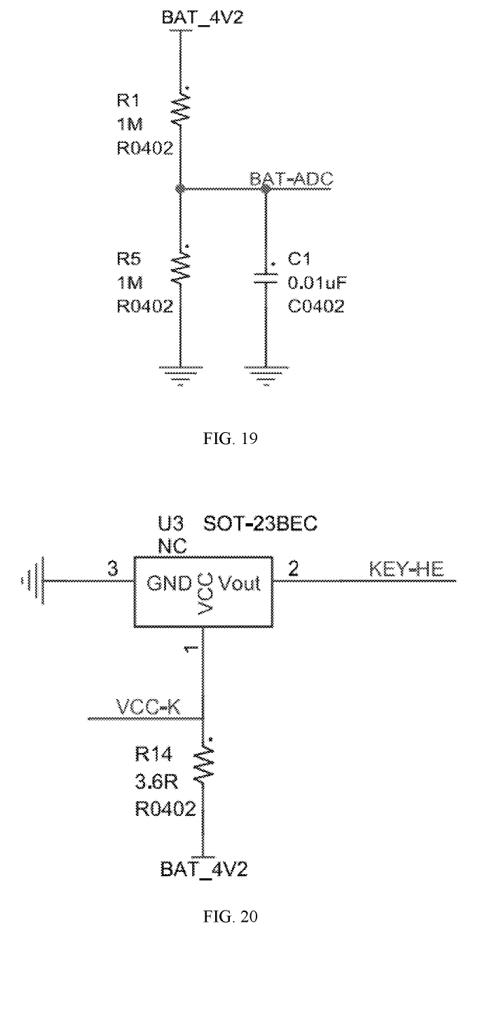

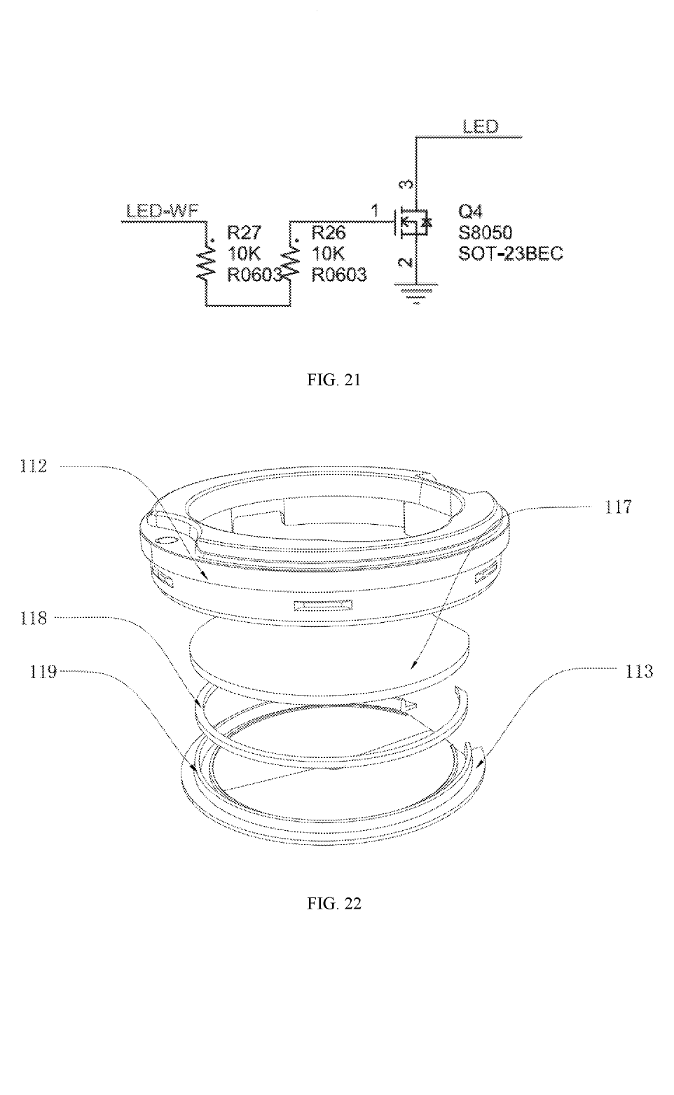

Referring to FIGS. 12-21, this embodiment further provides a control circuit for a UVC light disinfection makeup box, including a core control unit, an induction unit, an execution unit, and a power supply unit. The four units each perform their respective duties and work closely together. The core control unit acts as a brain to coordinate and schedule, the induction unit acts as the sensor to collect state, the execution unit acts as an executor to complete specific functions, and the power supply unit acts as an energy source to provide power, collectively forming the complete working system of the circuit. The induction unit is configured to collect the mechanical state signal of the UVC light disinfection makeup box and convert it into an electrical signal. The mechanical state signal is mainly the opening and closing action of the flip cover. The converted electrical signal must have stable and easily recognizable characteristics to provide accurate input for the core control unit. The core control unit receives the electrical signal from the induction unit, and outputs a control electrical signal to the execution unit after internal processing. The internal processing includes signal parsing, logical judgment, and instruction generation to ensure that the control signal can accurately match the work requirements of the execution unit. The power supply unit provides stable working power for the core control unit, induction unit, and execution unit. The stable power supply can avoid voltage fluctuations that may cause component performance abnormalities or functional failures, ensuring the continuous and reliable operation of the circuit. Through the collection, processing, and output the electrical signal, it realizes the linkage control of disinfection, supplementary lighting, state display, and charging. The linkage control allows various functions to automatically switch according to the usage scenario, without the need for manual operation by the user, improving the convenience and intelligence of use.

The core control unit is the PCB control board 114. As the core carrier of the control circuit, the PCB control board has high integration and compact layout, which can effectively save installation space and ensure the stability of signal transmission between various circuits. The PCB control board 114 integrates a signal processing circuit, a drive control circuit, and a voltage detection circuit. The signal processing circuit is responsible for parsing the electrical signals transmitted by the induction unit, extracting effective information. The drive control circuit amplifies the processed signal into control instruction that can be recognized by the execution unit. The voltage detection circuit monitors the power supply voltage in real time, thereby providing a basis for low battery warning, used to analyze the electrical signal transmitted by the induction unit and output adapted the control electrical signal to the execution unit. The analysis process needs to be fast and accurate, and the adapted control electrical signal can ensure timely and accurate response of the execution unit’s actions, avoiding functional triggering errors. At the same time, real-time monitoring of the voltage state of the power supply unit is carried out. When the voltage is lower than a preset threshold, a low battery warning signal is output by the execution unit. The preset threshold needs to be set according to the battery performance, which can not only avoid excessive discharge and damage to the battery, but also reserve enough power to remind the user to charge. The warning signal is usually implemented through a specific flashing mode of the LED atmosphere light, which is intuitive and easy to understand.

The induction unit is a hall sensor 21, which has the characteristics of high sensitivity and rapid response. It can accurately capture magnetic field changes and convert them into the electrical signal, and is a key component for achieving state sensing. The hall sensor 21 cooperates with the flip magnet 13 and the hall induction magnet 17 of the UVC light disinfection makeup box through a magneto electric conversion circuit. When the flip magnet and hall induction magnet are closed, they adsorb and generate a magnetic field change. The magneto electric conversion circuit converts the magnetic field change into a communicable electrical signal, ensuring the effective generation of the induction signal. The opening and closing mechanical state of the flip cover 11 is converted into high and low level electrical signals, with a high level corresponding to an open of the flip cover, and a low level corresponding to a close of the flip cover. A distinction between high- and low-level signals is clear, rendering it easy for the core control unit to quickly identify. Sent to the core control unit through the signal transmission circuit, the signal transmission circuit must have low loss and anti-interference characteristics to ensure that the electrical signal is not distorted or delayed during transmission. The execution unit includes a UVC ultraviolet disinfection light driver circuit, an LED colorful atmosphere light control circuit, and an LED white light fill circuit. The three circuits correspond to the three core functions of disinfection, state feedback, and supplementary lighting, respectively, with strong pertinence. Receive control signals from the core control unit separately to achieve precise control of start and stop of the UVC ultraviolet disinfection light 22, mode adjustment of the LED colorful atmosphere light 23, and a conduction of a circuit of LED white light 31. UVC light start stop control ensures disinfection effectiveness and safe use. Atmosphere light mode adjustment provides feedback on charging, disinfection, low power, and other states through different colors and flashing states. White light conduction control meets the needs of supplementary lighting in dim environments, and precise control can avoid functional disorders and improve user experience.

The power supply unit includes a battery 115 and a charging management circuit. The battery is a lithium battery that is suitable for the size of the makeup box, and the capacity needs to balance the endurance and installation space. The charging management circuit is responsible for safe charging and voltage conversion, and the two work together to achieve integrated management of power supply and charging. The battery 115 is electrically connected to the core control unit, induction unit, and execution unit through a power supply circuit, providing working power for each unit. The power supply circuit integrates voltage regulation and current limiting functions, which can convert the voltage output by the battery into a working voltage suitable for each unit, ensuring that different components can obtain stable and safe power supply, and avoiding component damage caused by voltage mismatch. The charging management circuit is electrically connected to a USB interface 24, which adopts a universal specification, rendering it convenient for users to charge through conventional chargers, computers, and other devices, thereby improving user convenience. By using a rectification and voltage stabilization circuit, the external input power is converted into an appropriate voltage to charge the battery 115. The rectification and voltage stabilization circuit can convert unstable Alternating Current, (AC) or Direct Current, (DC) power from the outside into stable DC power required for battery charging, preventing overvoltage and overcurrent damage to the battery, and the charging state signal is transmitted to the core control unit through a signal feedback circuit. The signal feedback circuit can capture the charging progress in real time, transmit the state signal to the core control unit, and then feedback it to the user through the LED atmosphere light 23 of the execution unit, thereby allowing the user to clearly grasp the charging situation.

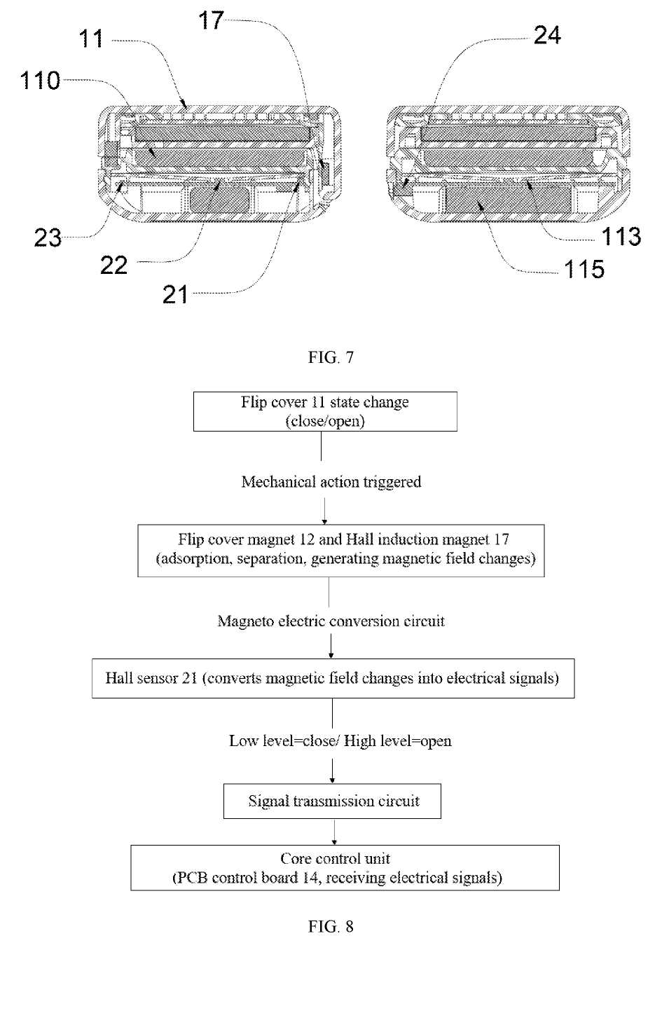

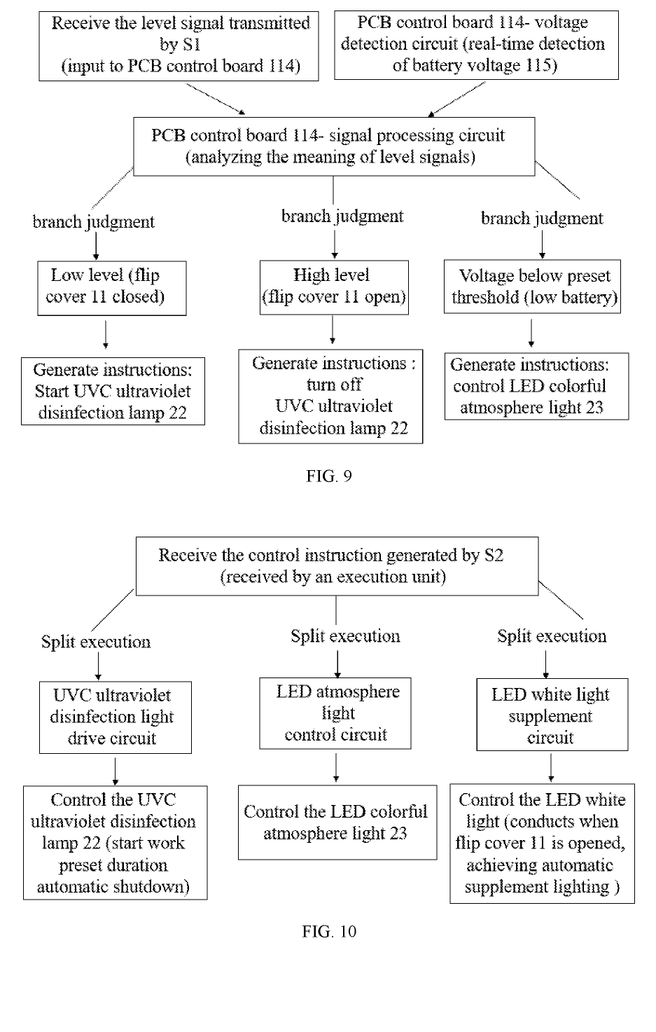

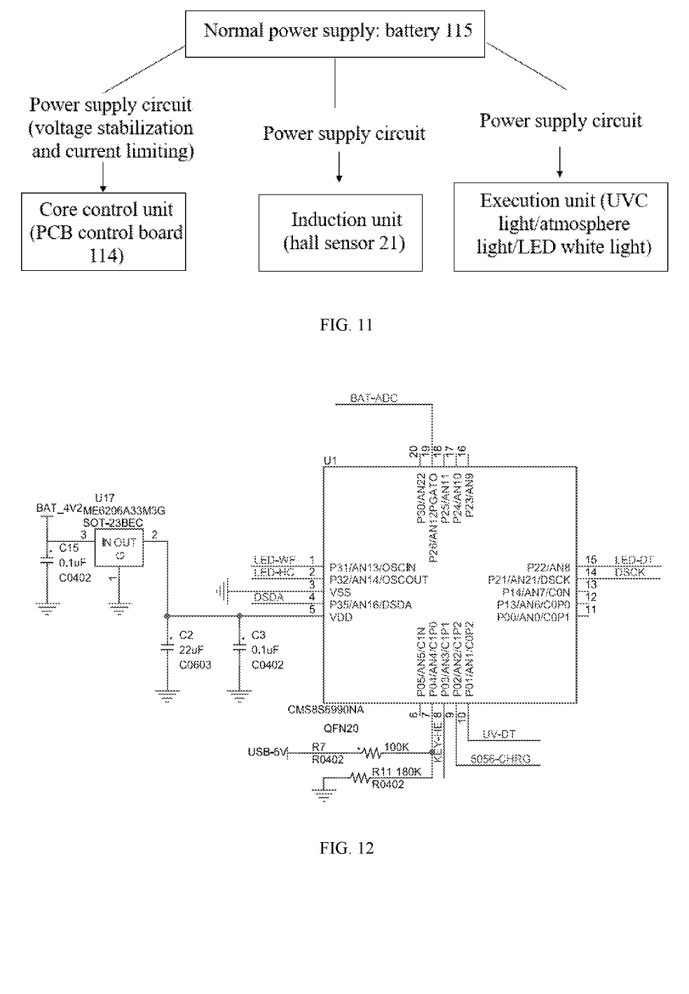

Referring to FIGS. 8-11, an embodiment of the present disclosure further provides a control method of a UVC light disinfection makeup box, including the following steps:

S1: state induction and signal conversion, a hall sensor 21 cooperates with a flip magnet 13 and a hall induction magnet 17 through a magneto electric conversion circuit to detect opening and closing mechanical state of the flip cover 11 in real time, converting a close state into a low-level electrical signal and an open state into a high-level electrical signal, and sending it to a PCB control board 114 through a signal transmission circuit;

S2: signal analysis and instruction generation, after receiving the electrical signal transmitted by the induction unit, the PCB control board 114 analyzes state information through an integrated signal processing circuit and a voltage detection circuit monitors a voltage state of a power supply unit in real time; when it is a low level, the flip cover 11 is closed, output a control signal to activate a UVC ultraviolet disinfection light 22 and a LED colorful atmosphere light 23 in a blue light mode; when it is a high level, the flip cover 11 is opened, output a control signal to turn off the UVC ultraviolet disinfection light 22 and start the LED white light 31 for supplementary lighting; when a voltage is lower than a preset threshold, output a low battery warning control signal;

S3: instruction execution and function implementation, the execution unit receives an instruction from a core control unit (PCB control board 114), a UVC ultraviolet disinfection light drive circuit is turned on, controls the UVC ultraviolet disinfection light 22 to start and work for a preset time, and automatically shuts off after disinfection is completed; the LED atmosphere light control circuit switches modes according to an instruction; where blue light display disinfection, green breathing display charging, red flashing display low battery, etc., the LED white light supplement circuit is turned on, controlling the LED white light 31 to turn on, achieving automatic supplement lighting when the flip cover 11 is opened;

S4: power management and state feedback, the power supply unit provides stable working power to the PCB control board 114, the hall sensor 21, and the execution unit through the power supply circuit via the battery 115;

S401: charging management: during charging, the charging management circuit receives an external power through a USB interface 24, rectifies and stabilizes the voltage to charge the battery 115, and transmits a charging state to the PCB control board 114 through a signal feedback circuit, the LED colorful atmosphere light 23 then feeds back to a user, forming a closed-loop management of power supply, control, and feedback.

### Embodiment 2:

Referring to FIG. 22, the present disclosure further provides a second embodiment. The difference between this second embodiment and the first embodiment is that the transparent shoulder cover 112 in the second embodiment adopts a hollow design, and its lower surface is hollow. An upper surface of the transparent light guide plate 113 is provided with a convex platform 119, and an inner wall of the convex platform 119 is sequentially inserted with a linetightening sheet 118 and a transparent piece 117 from top to bottom. In this way, the light emitted by the device can pass through the transparent piece 117 and the transparent shoulder cover 112, which can achieve better disinfection effect during use and improve the aesthetics of the device. In this embodiment, the transparent piece 117 is made of quartz glass.

Although the embodiments of the present disclosure have been shown and described, it will be understood by those skilled in the art that various changes, modifications, substitutions, and variations can be made to these embodiments without departing from the principles and spirit of the present disclosure. The scope of the present disclosure is limited by the appended claims and their equivalents.

What is claimed is:

1. A UVC light disinfection makeup box, comprising a housing component, a control component, and a lens component;
wherein the housing component comprises a bottom shell and a flip cover, the flip cover is rotatably connected to the bottom shell;
the control component is integrated into the bottom shell, and the lens component is provided inside the flip cover;
the control component is linked with the housing component and the lens component through electrical signal transmission,
after collecting a state sensing signal of the housing component and processing it, a control signal is output to the lens component and an execution component to achieve automatic control of disinfection, supplementary lighting, and state display functions;
wherein the lens component is matched with the housing component.

2. The UVC light disinfection makeup box according to claim 1, wherein the housing component further comprises a powder holder, an aluminum dish for loading powder material, a powder puff, a flip magnet, a hall induction magnet, a transparent light guide plate, a transparent silicone inner cover, a rear button cover, and a shoulder magnet;
the powder holder is fixedly provided inside the bottom shell, and the aluminum dish for loading powder material is configured to be detachably connected to the powder holder; the powder puff is provided above the powder holder and corresponding to the aluminum dish for loading powder material;
the flip magnet is fixedly provided inside the flip cover, the hall induction magnet is fixedly provided inside the transparent shoulder cover and aligned with the flip magnet,
the transparent light guide plate is provided inside the bottom shell and close to the control component, the transparent silicone inner cover covers an outer side of a lens, the rear button cover is fixedly provided to a tail of the bottom shell, and the shoulder magnet is fixedly provided inside the transparent shoulder cover to enhance connection and fixation between the transparent shoulder cover and the bottom shell;
the control component comprises a PCB control board, a hall sensor, a UVC ultraviolet disinfection light, an LED colorful atmosphere light, and a battery;
the PCB control board is fixedly provided inside the bottom shell, and the hall sensor, the UVC ultraviolet disinfection light, and the LED colorful atmosphere light are respectively electrically connected and fixedly provided to the PCB control board through a welding circuit;
the battery is electrically connected to the PCB control board through a power supply circuit; the flip magnet and the hall induction magnet output induction electrical signals to the hall sensor through a magneto electric conversion circuit;
the hall sensor transmits the electrical signals to the PCB control board, and the PCB control board controls on/off of a circuit of the UVC ultraviolet disinfection light and the LED colorful atmosphere light through a drive circuit.

3. The UVC light disinfection makeup box according to claim 2, wherein the lens component comprises the lens, a lens PCB light board, an LED white light, and a lens PCB light board output port,
the lens is fixedly provided at an inner side of the flip cover, the lens PCB light board is fixedly provided inside the flip cover and provided on one side of the lens,
the LED white light is fixedly provided to the lens PCB light board through a welding circuit and is aligned with the lens; the lens PCB light board is provided with a lens PCB light board input port and the lens PCB light board output port;
the lens PCB light board output port is electrically connected to the PCB control board through a signal transmission circuit via the lens PCB light board input port, and the lens PCB light board output port cooperates to achieve stable transmission of circuit signals;
the PCB control board outputs a supplementary lighting control electrical signal to drive the LED white light circuit to conduct, achieving automatic supplementary lighting when the flip cover is opened.

4. The UVC light disinfection makeup box according to claim 3, wherein the flip cover is rotatably connected to the bottom shell through a hinge structure, and when the flip cover is closed, the flip magnet and the hall induction magnet are attracted, the hall sensor is triggered to generate an induction electrical signal, and the electrical signal is sent to the PCB control board through the signal transmission circuit;
the PCB control board starts the UVC ultraviolet disinfection light to work for a preset time, and controls the LED colorful atmosphere light to output a blue light state signal through an atmosphere light control circuit;
when the flip cover is opened, the hall sensor stops outputting the induction electrical signal, and the PCB control board immediately turns off the UVC ultraviolet disinfection light and starts the LED white light to achieve functional linkage control;
a lower surface of the transparent shoulder cover is arranged to be hollow or solid.

5. The UVC light disinfection makeup box according to claim 4, wherein the lower surface of the transparent shoulder cover is configured to be a hollow shape, and an upper surface of the transparent light guide plate is provided with a transparent piece, and the transparent piece is a quartz glass.

6. A control circuit of the UVC light disinfection makeup box according to claim 1, comprising: a core control unit, an induction unit, an execution unit, and a power supply unit;
the induction unit is configured to collect a mechanical state signal of the UVC light disinfection makeup box and convert it into an electrical signal;
the core control unit receives the electrical signal from the induction unit, processes it internally, and outputs a control electrical signal to the execution unit;
the power supply unit provides stable working power for the core control unit, the induction unit, and the execution unit;
through collection, processing, and output the electrical signal, a linkage control of disinfection, supplementary lighting, state display, and charging is achieved.

7. The control circuit of the UVC light disinfection makeup box according to claim 6, wherein the core control unit is a PCB control board, and the PCB control board integrates a signal processing circuit, a drive control circuit, and a voltage detection circuit, and they are configured to analyze the electrical signal transmitted by the induction unit, output the control electrical signal to the execution unit, and monitor a voltage state of the power supply unit in real time;
when the voltage is lower than a preset threshold, a low battery warning signal is output through the execution unit.

8. The control circuit of the UVC light disinfection makeup box according to claim 6, wherein the induction unit is a hall sensor, and the hall sensor cooperates with the flip magnet and the hall induction magnet of the UVC light disinfection makeup box through a magneto electric conversion circuit to convert opening and closing mechanical state of the flip cover into high and low level electrical signals, and sends them to the core control unit through a signal transmission circuit;
the execution unit comprises a UVC ultraviolet disinfection light drive circuit, an LED colorful atmosphere light control circuit, and an LED white light fill circuit, which respectively receive the control signal from the core control unit to achieve precise control of start and stop of the UVC ultraviolet disinfection light, mode adjustment of the LED colorful atmosphere light, and a conduction of a circuit of the LED white light.

9. The control circuit of the UVC light disinfection makeup box according to claim 6, wherein the power supply unit comprises a battery and a charging management circuit, the battery is electrically connected to the core control unit, the induction unit, and the execution unit through the power supply circuit, thereby providing working power for each unit;
the charging management circuit is electrically connected to a USB interface, and converts an external input power supply into an adapted voltage through a rectification and stabilization circuit to charge the battery;
a charging state signal is transmitted to the core control unit through a signal feedback circuit.

10. A control method of a UVC light disinfection makeup box, comprising the control circuit of the UVC light disinfection makeup box according to claim 6, and the control method comprises the following steps:
S1: state induction and signal conversion, a hall sensor cooperates with a flip magnet and a hall induction magnet through a magneto electric conversion circuit to detect opening and closing mechanical state of the flip cover in real time, converting a close state into a low-level electrical signal and an open state into a high-level electrical signal, and sending it to a PCB control board through a signal transmission circuit;
S2: signal analysis and instruction generation, after receiving the electrical signal transmitted by the induction unit, the PCB control board analyzes state information through an integrated signal processing circuit and a voltage detection circuit monitors a voltage state of a power supply unit in real time; when it is a low level, output a control signal to activate a UVC ultraviolet disinfection light and a LED colorful atmosphere light in a blue light mode; when it is a high level, output a control signal to turn off the UVC ultraviolet disinfection light and start the LED white light for supplementary lighting; when a voltage is lower than a preset threshold, output a low battery warning control signal;
S3: instruction execution and function implementation, the execution unit receives an instruction from the PCB control board, a UVC ultraviolet disinfection light drive circuit is turned on, controls the UVC ultraviolet disinfection light to start and work for a preset time, and automatically shuts off after disinfection is completed; the LED atmosphere light control circuit switches modes according to an instruction; the LED white light supplement circuit is turned on, controlling the LED white light to turn on, achieving automatic supplement lighting when the flip cover is opened;
S4: power management and state feedback, the power supply unit provides stable working power to the PCB control board, the hall sensor, and the execution unit through the power supply circuit via the battery;
S401: charging management: during charging, the charging management circuit receives an external power through a USB interface, rectifies and stabilizes the voltage to charge the battery, and transmits a charging state to the PCB control board through a signal feedback circuit, the LED colorful atmosphere light then feeds back to a user, forming a closed-loop management of power supply, control, and feedback.
